(19) United States
(12) Patent Application Publication
(10) Pub. No.: US 2008/0240860 A1
(43) Pub. Date: Oct. 2, 2008

(54) SYNTHETIC DRAINAGE AND IMPACT ATTENUATION SYSTEM

(76) Inventor: Peter J. Ianniello, Havre de Grace, MD (US)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 11/924,304

(22) Filed: Oct. 25, 2007

Related U.S. Application Data
(63) Continuation-in-part of application No. 10/232,811, filed on Sep. 3, 2002, now Pat. No. 6,802,669.
(60) Provisional application No. 60/862,805, filed on Oct. 25, 2006.

(51) Int. Cl. B65G 5/00

(52) U.S. Cl. 405/53

(57) ABSTRACT

A channeled synthetic drainable base course for use with natural or synthetic turf systems. The synthetic drainable base course provides for permeability and transmissivity of fluids, shock resistance when tested for fall impact safety and reduced installation effort and time. The synthetic drainage system may be installed as a separate component or as a composite layer of a turf system.

### REFERENCE TO RELATED APPLICATIONS

The present application claims priority to U.S. Provisional Application No. 60/862,805, filed Oct. 25, 2006. The present application is also a Continuation-In-Part of U.S. patent application Ser. No. 10/232,811, filed Sep. 3, 2002 (now allowed). The present application also claims priority to U.S. patent application Ser. No. 09/501,324, filed Feb. 10, 2000, to U.S. patent application Ser. No. 09/501,318, filed Feb. 10, 2000, and U.S. Provisional Application No. 60/316,036, filed Aug. 31, 2001 and U.S. patent application Ser. No. 10/691,975 filed Oct. 24, 2003. The cited Applications are hereby incorporated by reference in their entireties.

### FIELD OF THE INVENTION

The present invention is directed generally to synthetic turf systems for use with sportsfields and play areas and more specifically to a synthetic base course for improving the drainage and impact attenuation thereof.

### BACKGROUND OF THE INVENTION

The present invention pertains to means and methods for extending the life of paved structures such as highways and airport runways by providing improved and novel drainage geocomposites comprising primarily void-maintaining geosynthetic membrane laminates that can be installed economically with conventional road building and construction equipment.

As was identified in Ianniello et al in pending patent application 20040131423 “High-flow void-maintaining membrane laminates, grids and methods” water is a principal cause of distress and damage to paved structures such as roadways, airport runways and parking lots. Similarly, in sport fields of natural and synthetic turf construction drainage systems are often provided in such sport field in order to remove water from the sport field and its foundations to thereby extend the useful life of the sport field. In some drainage methods, drainage systems are incorporated between the native soils or “subgrade” upon which a sport field is situated and the overlying turf system. The present invention relates generally to synthetic void-maintaining structures with high permittivity and high transmissivity that are capable of extending the life of sport fields by maintaining voids of sufficient dimensions to permit the timely egress of undesirable fluids, especially aqueous fluids.

In conventional sport field design, natural stone and aggregate materials are placed to form a drainable layer that is commonly called an Open Graded Base Course, or “OGBC.” OGBC's are typically used underneath the sport surface. The present invention provides a series of high-flow void-maintaining membrane laminate (“VMML's”) of polymeric material and related methods for economically manufacturing such laminates such that the need for an OGBC can be eliminated or minimized.

Sport fields are now highly engineered layered structures. Because of this, sport fields require engineered materials that are selected based upon factors such as their density, particle or aggregate size, compressibility or other engineering parameters of the soil, stone and aggregate-based products that are required as structural fill that typically is installed in layers beneath sport surfaces.

Two types of structural fill are the base course and, typically immediately beneath the base course, a sub-base course. Fluids such as water that become trapped or retained within structural fill cause damage to sport fields and, over time, subsequently greatly reduce the useful life of a sport field.

The cause of many premature sport field failures has been traced to sport field inadequate subsurface drainage. Typically, fluids enter the subsurface layers of sport fields when there is a high fluid content within soil or other layers supporting sport field premature collapse or failure of the sport field may occur. Thus, damage to sport fields occurs when fluid such as water is retained. In promulgating standards for quantifying the drainage performance the inventors incorporated AASHTO guidance in manners similar to the parent application which conceived of structures such as highways and other paved surfaces, but applied them in manners non obvious to sport field applications. Thus the present invention obtains an AASHTO classified performance of “excellent,” so that water is removed from the sport field system within two hours as compared to “poor,” where water is removed within one month. In sport fields, there has never been a designation of drainage coefficients that correspond to AASHTO ratings. Thus, the inventors apply the design parameters in highway construction in nonobvious manners to sport fields. For example, the drainage coefficient corresponding to an “excellent” drainage system in a sport field section would typically he at least two times greater than the corresponding drainage coefficient for “poor” drainage system in a similar section of sport field. In general, a drainage system having a higher drainage coefficient increases the corresponding effective structural rating of a section of sport field. Therefore, higher drainage coefficients generally correspond to a longer or extended service life, or result in the reduction of the overall structural cross-section, and therefore the amount of engineered materials, necessary to support a sport field.

Other engineering parameters reflect the importance of sufficient drainage to sport fields. For example, the presence of water in sport field causes a reduction of the resilient modulus, which reduces the ability of a sport field surface to maintain flatness. The examiner may note that in 1993, AASHTO reported that water saturation can reduce the dry modulus of asphalt paving by 30% or more. Moreover, added moisture in unbound aggregate base and sub-base layers was estimated to result in a loss of stiffness on the order of 50% or more. With water retention, a modulus reduction of up to 30% can be expected for an asphalt-treated base as well as an increased erosion susceptibility of cement or lime-treated bases. In addition, with inadequate drainage, saturated fine-grain roadbed soil may experience modulus reductions of over 50%. The present invention applies this information in a nonobvious manner and prevents fluids buildup and in turn improves the support the sport field system.

Premature failure of sport field systems results in unacceptable costs. One conventional approach to the prevention of such premature failure from occurring has been directed toward developing means and methods for waterproofing sport fields. This is performed with a myriad of membrane or liner type products. Thus, at the present time, industry focus attempts to prevent water from entering the sport field.

The present invention seeks to apply art known on the design of roads to sport fields in non-obvious manners. For example, in such publication is Drainage of Highway and Roads. H. R. Cedegren (1987, R. E. K. Publishing Co.). In his book, Cedegren emphasizes that proper base and subbase drainage are considered to be more essential than paved surface waterproofing with respect to assuring that a road will perform for the duration of its design life. Cedegren projects that a road life can be extended up to three times (e.g., a service life can be extended from 15 years, to 45 years) if adequate subsurface drainage systems are installed and maintained.

The economic disadvantages of inadequate subsurface drainage are significant. For example, the Maine DOT has observed that for an additional 20% increase in initial construction costs, proper drainage can double the expected useful life of a road. Studies by the University of Maine have quantified these observations with respect to actual soil permeability of various road bases throughout Maine. The University of Maine studies concluded that roads constructed with as little as 4% fines within the base and subbase courses drained at very slow rates, only two feet per day. This means that if a road, such as one observed in the study, had water traveling a typical distance of 20 feet, that is, 2 feet downwardly and 18 feet horizontally to a ditch or drain at the road's edge, it would take ten days for the road to drain, even if no additional fluids entered that same section of the road. Unfortunately, for the sport field designer, there is no similar design guidance. Therefore, the inventors incorporate the use of road design methodology in a nonobvious manner and conceive of new and novel ways to drain fluids from sport fields with required performance in a non-obvious manner.

Thus, the rate at which water and other fluids are transported away from the various layers or levels of a sport field is a critical element in its useful life. As can be easily seen, premature sport field failure due to inadequate drainage is an extremely serious and costly problem affecting the owner.

Prior to the present invention, the conventional method of approaching these drainage problems, utilized an Open Graded Base Course, or “OGBC,” drainable layer formed of natural stone and aggregate materials installed beneath a sport field in an attempt to positively control and dissipate fluids which commonly accumulate on the playing sport, field surface. Typically, an OGBC-drainable sport field includes a layer of stone or sand and an edge drain, in theory, an OGBC drainable sport field provides a fluid-permeable mm beneath the sport field surface in order to alleviate the hydraulic problems attendant to poor drainage. On the other hand, the optimal performance of a sport field system, is achieved by preventing water from, entering the sport field and removing any water that does enter by means of a well-designed subsurface drainage system.

An OGBC is intended to be a porous drainage media that is capable of receiving fluids from the points of entry and then transporting them to designated discharge points in a timely manner. According to the FHWA, a typical OGBC permeable base is estimated to have a minimum permeability of 1,000 lineal feet per day. A permeability in this range will allow for drainage of the overlying sport field to occur within a few hours and thus would be considered as “excellent drainage” as defined by AASHTO. Because OGBC is installed as a highly porous and permeable system underneath an entire sport field section, it affords drainage to fluids regardless of their points of entry. For these reasons, OGBC has been viewed in the field as having acceptable parameters of fluid interception and drainage with respect to sport field systems.

OGBC is typically produced from stone that has been mined from quarries. A main distinguishing characteristic of OGBC materials is that they are usually delivered to work sites having a fairly uniform gradation per the specifications of the project engineer. Typically, project engineers use published standards for OGBC available from AASHTO, the Federal Highway Administration, or their resident state's department of transportation. Theoretically, uniform gradation of OGBC materials typically creates voids of desired and predictable dimension between them when they are in place. Thus, desired flow rates through both vertical and horizontal planes of the OGBC can be increased or decreased somewhat predictably by selecting appropriate size distributions of the particulate material.

Nonetheless, there are many disadvantages in OGBC drainage systems that appear to be caused by the lack of mechanical and dimensional stability provided by using uniform size gradations of stone. Although such gradations create interconnecting void spaces or holes with the aggregate for the purpose of receiving and transmitting fluid, OGBC by its very nature is susceptible to unacceptable amounts of lateral movement when exposed to shear stresses.

Although an OGBC's interconnected void spaces may afford an acceptable level of drainage for some applications, the use of an OGBC conflicts with many established design practices. Another particular problem with the use OGBC's for drainage relates to their long-term performance. It is not uncommon to find distress in some OGBC systems after only a few years of apparently satisfactory service. Initial indications are that the drainage from the system has slowed and that the sport field and one or more base layers are moving with respect to one another, resulting in loss of sufficient support to overlying sport field layers. For this and related reasons, current concerns now focus on the long-term stability and hydraulic conductivity of the open-graded bases and their effect on sport field performance.

The hydraulic conductivity of OGBC's over time is susceptible to the deleterious clogging effects of the upward migration of subgrade soil particles into the layer, as well as from the infiltration of fine particles from fractures in the sport field surface. While there is still a need to determine the optimum balance between stability and hydraulic conductivity for the least cost, equally important is the need to identify construction methods and materials for maintaining the initial stability and hydraulic characteristics of an OGBC over time.

Yet another problem with the OGBC is that quality aggregate is not always available or, if available, at uneconomically or prohibitively high costs. There is therefore a need for a drainage system that utilizes components which can be engineered and manufactured offsite, which provide equivalent or superior flow to OGBC's and that can be integrated economically within a sport field to provide efficient and cost-effective drainage for the structure, while also providing sufficient dimensional, mechanical and hydraulic capability.

In general, geosynthetics are manufactured from polymeric materials, typically by extrusion, as substantially planar, sheet-like, or cuspidated products. Geosynthetics are usually made in large scale, e.g., several meters in width and many meters in length, so that they are easily adaptable to large-scale construction and landscaping uses. Many geosynthetics are formed to initially have a substantially planar configuration. Some geosynthetics, even though they are initially planar, are flexible or fabric-like and therefore conform easily to uneven or rolling surfaces. Some geosynthetics are manufactured to be less flexible, but to possess great tensile strength and resistance to stretching or great resistance to compression. Certain types of geosynthetic materials are used to reinforce large man-made structures, particularly those made of earthen materials such as gravel, sand and soil. In such uses, one purpose of using the geosynthetic is that of holding the earthen components together by providing a latticework or meshwork whose elements have a high resistance to stretching. By positioning a particular geosynthetic integral to gravel, sand and soil, which is with the gravel, sand and soil resident within the interstices of the geosynthetic, unwanted movement of the earthen components is minimized or eliminated.

Most geosynthetic materials, whether of the latticework type or of the fabric type, allow water to pass through them to some extent and thus into or through the material within which, the geosynthetic is integrally positioned. Thus, geosynthetic materials and related geotechnical engineering materials are used as integral part of manmade structures or systems in order to stabilize their salient dimensions.

Until recently, the only geosynthetic materials available for sport field drainage were very limited. Conventional geosynthetics were difficult to install beneath sport field surfaces.

The present invention thus offers a range of synthetic void-maintaining laminate products, which overcome the many deficiencies of the OGBC. The present invention relates generally to synthetic void-maintaining structures with high permittivity and high transmissivity that are capable of extending the life of sport field by removing undesirable fluids. The present invention includes a myriad of high-flow void-maintaining membrane laminates (“VMML's”) which possess desirable properties that make them capable of being a suitable partial, or full, replacement for conventional sport field materials such as OGBC's.

The preferred embodiments of the present invention of high throughput void-maintaining laminates overcome the previously mentioned disadvantages by providing a plurality of interconnected porous drainage medium and voids of great mechanical and dimensional stability while simultaneously providing sufficient horizontal flow to perform in accordance with “Good to Excellent” drainage when assessed with AASHTO definitions. These performance attributes are one desirable aspect of the present invention because they eliminate many of the problems associated with fluids underlying large structures that are not resolved by conventional OGBC systems or by other geosynthetic products. By reducing or eliminating these problems the useful life of the overlying sport field structure is extended.

In accordance with other aspects of the present invention, can be positioned in a sport field to maximize their effectiveness, for example, directly beneath the sport field surface, immediately beneath the base course, or directly above a sub-grade if a sub-base is not present.

Embodiments of the invention can be made in large pieces, for example, several meters wide and many meters long. Moreover, for convenience in installation, the present invention may be installed in portions which are interconnected such that the interconnecting voids are of sufficient dimension that the water from a sport field can move freely through the invention and can be connected to drain means such as a perforated pipe, ditch, or culvert adjacent to the sport field structure.

The present invention can be fabricated into panels of various lengths and widths by using a means to weld, tie or sew sections to one another to form one or more continuous pathways underneath a sport field. Typically, the present invention is positioned so that it is installed beneath sport field and above the natural soil native to the construction site or above a membrane. Also typically, the present invention reduces the distance to drain from the horizontal plane governed by the slope to the vertical distance between the SDBC and the fluid entry point.

### SUMMARY OF THE INVENTION

It is therefore an object of the present invention to provide high resistance to compression when under load, while maintaining desired flow characteristics through their upper layers and cores.

It is also an object of the invention to provide means and methods for combining two or three layers of thermoplastic into such geocomposite laminates or forming particulate materials into said laminates.

It is a similar object of the invention to be constructed and arranged to meet specified performance characteristics.

By choosing one or more shapes, sizes and densities of compression elements as disclosed herein, and by combining them with a base layer and a top layer also as described herein, embodiments of the present invention can be provided. For example, the present invention may have a transmissivity of at least 10.sup.−3 M sec.sup.−1 of aqueous liquid at a normal load of at least 100 PSF (pounds/ft.sup.2), sustainable for at least 100 hours when tested in accordance w/ASTM 4716 as well as those having a transmissivity of at least 10.sup.−3 M sec.sup.−1 of aqueous liquid at a normal load of at least 1,000 PSF (pounds/ft.sup.2) sustainable for at least 100 hours when tested in accordance w/ASTM 4716, and those possessing a transmissivity of at least 10.sup.−3 M sec.sup.−1 of aqueous liquid at a normal load of at least 10,000 PSF (pounds/ft.sup.2) sustainable for at least 100 hours when tested in accordance w/ASTM 4716.

Synthetic turf systems are well known. They are used as an alternative to natural grass surfaces because they stand up better to wear and severe weather and typically require less maintenance. Prior art synthetic turf systems, such as Field Turf™, Sprint™ and ProGrass™, include a synthetic playing surface often coupled with rubber infill materials. These synthetic turf systems are typically installed above a natural sub grade. At times, these sub grades also incorporate synthetic drainage systems such as biplanars, triplanar, or cuspate cores. Examples of synthetic drainage systems are sold under the name Tenax™, Tendrain™, Mirafi™, Miradrain™, GSE™ and XL™.

Certain drawbacks exist with these prior art synthetic turf systems. For example, synthetic drainage systems such as the afore-mentioned Tenax™, Tendrain™, Mirafi™, Miradrain™, GSE™ and XL™ are all thermal set polymer based products that are produced and delivered in roll form. When unrolled these products do not lie flat because they are produced with thermal plastics, which causes them to have rigidity and memory of waves that cannot be pressed into place without appropriate normal loads typically encountered in construction or foundation applications. Many of these products require loads upwards of 85 lbs/sf to produce a sufficiently flat field surface whereas in typical sport field application the overlying normal loads are only 5 to 10 lbs per sf, insufficient to produce a sufficiently flat surface, which is an undesirable and dangerous defect on a playing surface that must be level.

In addition to the problems associated with rigidity and memory of waves, the prior art often requires considerable and costly rework on site that often includes methods to anchor, pin, nail, and seam the materials so that they could retain intimate contact with the sub grade. In fact, often times even after considerable rework, the only method that could utilize these materials requires the placement of a ballast material above the prior art. In fact, when utilizing the prior art, this was often required because the thermal plastics are subjected to coefficient of expansion and contraction, which caused further wrinkling even after placement occurred.

Unfortunately, numerous sports fields have been constructed with these products where the designers intended to simply place synthetic turf systems directly upon the synthetic drainage materials. Numerous constructability problems were encountered that prevented further and widespread acceptance of these products being used in combination with one another.

Injuries caused by collisions between athletes and hard surfaces are a common occurrence in sports. Consequently, Shock attenuation is an important property of sports surfaces, especially when impact carries a risk of severe injury. Artificial turf fields are required to exceed minimum shock attenuation criteria established by sports governing bodies and other agencies such as the Consumer Product Safety Commission, which sets guidelines for impact attenuation.

Synthetic fields are tested in accordance with Head Injury Criteria (HIC) and peak acceleration testing commonly referred to as (gₘₐₓ). Conventional prior art artificial turf typically cannot absorb the impact of an object (such as a head) without producing high gₘₐₓ and HIC scores. Other systems, particularly those synthetic turf systems that utilize rubber infill materials, have HIC and gₘₐₓ values that deteriorate overtime as a result of a consolidation of particulate robber matter and its possible combination with sand.

What is needed is a combination synthetic drainage and impact attenuation system that is deliverable in rolls yet will he flat without anchors, fasteners and the like, a system that does not require costly site preparation, a system that has superior impact attenuation qualities which do not significantly deteriorate over time or with use and a system with sustainable high vertical permeability and horizontal transmissivity of fluids.

The present invention is produced with a superior “flatness coefficient” (i.e., the ability to lay flat when unrolled), is highly resistant to thermal coefficient of expansion and contraction, provides long-term gₘₐₓ and energy absorption properties, is easy to install, provides long term vertical fluid infiltration and horizontal fluid transmission. The present invention's structure overcomes the limitations of the prior art and achieves these numerous and required properties such that one skilled in the art can design a sportfield therewith.

Other objects will, in part, be obvious and will, in part, appear hereinafter. The invention accordingly, comprises the features of construction, combination of elements and arrangements of parts, which will be exemplified in the following detailed description and the scope of the invention will be indicated in the claims.

### BRIEF DESCRIPTION OF THE DRAWINGS

For a better understanding of the present invention, reference is made to the drawings, which are incorporated herein by reference, and in which:

FIG. 1 is a cross sectional side view of a preferred embodiment of the present invention;

FIG. 2 is a cross sectional end view of the preferred embodiment of FIG. 1;

FIG. 3 is an enlarged cross sectional view of the preferred embodiment of FIG. 1; and

FIG. 4 is an enlarged cross sectional side view of the preferred embodiment of FIG. 1.

### DETAILED DESCRIPTION

For purpose of illustration, and not to limit generally, the present invention will now be described with specific reference to a synthetic drainable base course with drainage and impact attenuation properties for use with synthetic turf systems. One skilled in the art will appreciate, however, that embodiments of the present invention are not limited to synthetic turf systems and may, for example, be used with natural turf and other systems.

The present structure consists of selecting a gradation of polyethylene (“pe”) foam in order to allow vertical fluid transmission. Once the gradation is selected, it is randomly adhered together with either heat and or adhesives such that the end product retains a dimension stability of sufficient tensile and compressive strength that allows it to achieve 50% of its originally specified thickness and mechanical values even after 10,000 hours of exposure. Sufficient pressure is placed upon the particulate matter such that a desirable thickness is achieved. Once the particulate material has been bonded, drainage channels are molded into the present invention in order to allow horizontal fluid transmission. Lastly, the materials are planed to achieve a uniform thickness with only one mm variation across the width of a roll.

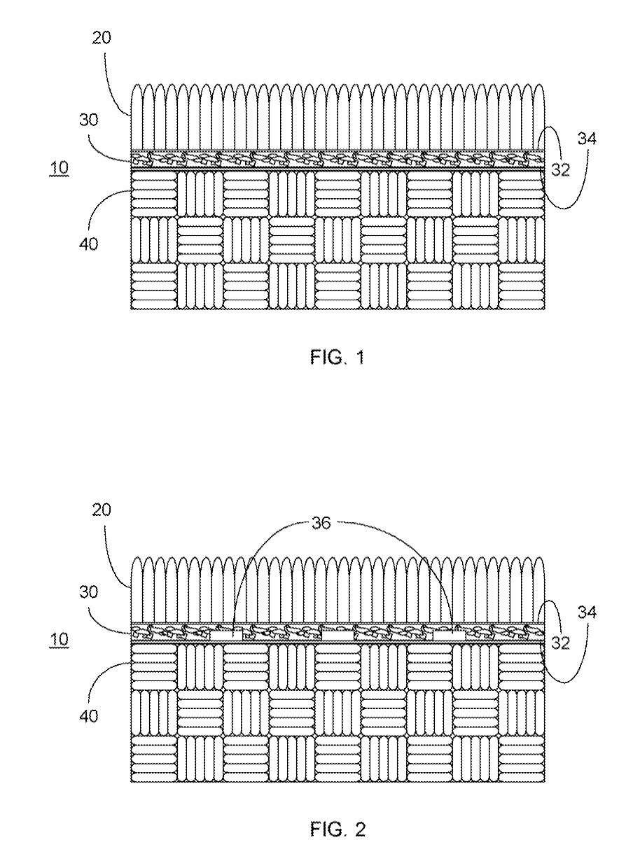

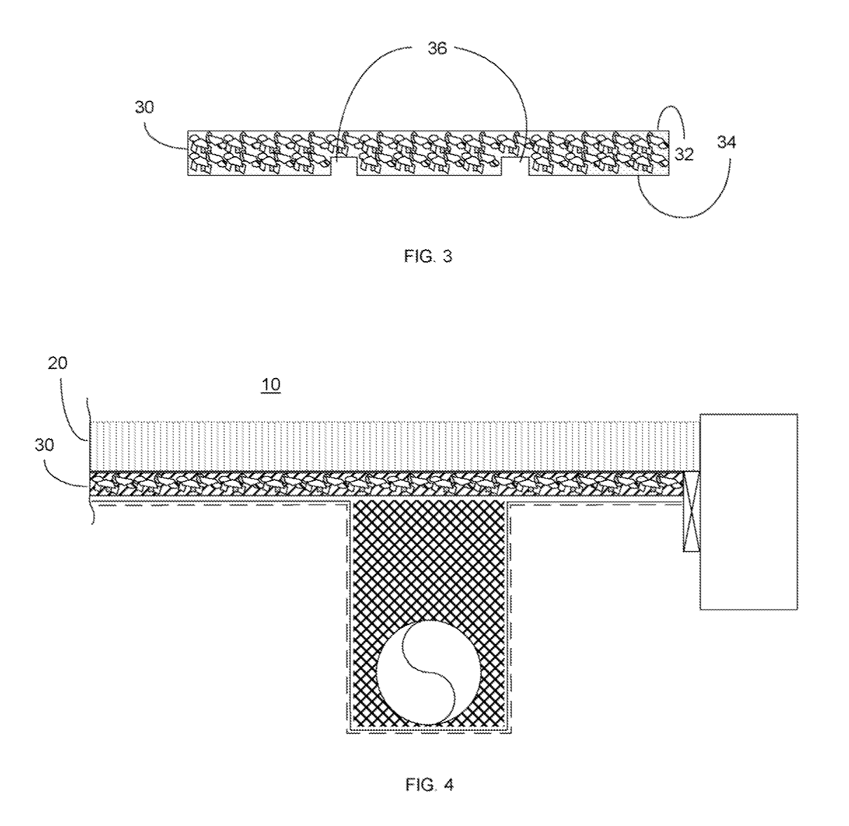

As shown in FIGS. 1 and 2, a synthetic turf system 10 comprises a synthetic playing surface 20. The synthetic playing surface 20 is installed over a synthetic drainable base course 30, which in turn rests on a subgrade 40. In the present embodiment, the synthetic drainable base course 30 comprises a layer of cross-link, closed cell polyethylene foam. The synthetic drainable base course 30 includes an upper surface 32 and a lower surface 34.

In a preferred embodiment, the synthetic drainable base course 30 is formed by first selecting a gradation of polyethylene foam that allows vertical fluid transmission through the synthetic drainable base course 30. Once the gradation is selected, it is randomly adhered together with heat and or adhesives such that the end product retains a dimension stability of sufficient tensile and compressive strength that allows it to achieve 50% of its originally specific thickness and mechanical values even after 10,000 hours of exposure.

The desired thickness of the synthetic drainable base course 30 is achieved by applying pressure to the particulate matter. Once the particulate matter has been bonded, a series of drainage channels 36 are molded or otherwise formed in the synthetic drainable base course 30, which provide horizontal fluid transmission. Drainage channels 36 may be of sufficient width and depth to maximize draining while providing desired shock absorbing characteristics. Spacing of drainage channels 36 may also be adjusted to provide superior draining characteristics while maintaining desired shock absorbing characteristics.

The upper surface 32 and the lower surface 34 may be planed to achieve a uniform thickness with preferably only 1 mm of variation across several feet of the material.

In certain embodiments the selected material is shredded, ground, or grated, with a ¾ mesh screen. This screen will not allow larger particles, similar to a sieve size. The shredding process does not allow larger particles to pass through the screen. Also the material is not likely to produce fines when shredded. In this embodiment, the present invention is similar to Asshto 57 stone, ¾ inch, no fines, same size particles.

In certain embodiments, various particles of the present invention are gap graded during manufacturing to maximize permeability as well as maintain long-term stability within the structure. This method of manufactures promotes long-term stability, which assures tensile properties will also be maintained. In certain embodiments of the present invention the edge detail, or in other words the distance from the edge from which a first drainage channel 36 is placed, is between 3″ to 6″ with certain embodiments showing superior results with a 4″ detail. This allows for the edge to have ballast resulting in a superior flatness coefficient and no curling.

Rolls of the present invention are preferably 4′ wide at a minimum to decrease longitudinal seams although other widths are contemplated. Rolls of the synthetic drainable base course 30 are preferably delivered and assembled in lengths that span an entire width of a field to eliminate any attachment, or seaming of materials end to end.

In certain embodiments of the present invention, the synthetic drainable base course 30 is created form like materials, i.e. HOPE to eliminate or minimize expansion and contraction. Schmitz uses a polypropylene netting, which reacts differently than HDPE at temperature. Also, the synthetic drainable base course 30 may include a textured bottom surface, winch minimizes movement on subgrade or membrane

Also, in certain embodiments the synthetic drainable base course 30 is produced from selected high-density cross-link PE foam. Certain prior art systems such as Schmitz do not have access to high density. Other prior art systems such as Sirex never differentiate between density, which tends to make their products soft and injury prone for field use.

In certain embodiments, drainage channels 36 are maximized to 2.5 to 3″ centers to provide excellent drainage and maximize fluid evacuation. Preferably the synthetic drainable base course 30 is manufactured under load or compression of 500 psf to minimize variance in thickness and maximize long-term durability.

Installation efficiency of the present invention is maximized because unlike certain prior art systems, there is no seaming and no friction fit puzzle design, which allows for a much faster install, up to five times faster, than any other prior art synthetic drainage layer.

Certain prior art products, such as Schmitz, must be kept at a constant temperature during assembly. Further, these systems require wetting and rewetting of their material during construction.

In one or more embodiments of the present invention the materials are formed to achieve a uniform thickness with only one mm variation across roll width. Drainage grooves are molded into the present invention in order to allow horizontal fluid transmission. The structure consists of selecting a gradation of HOPE cross-link pe foam in order to allow vertical fluid transmission. After gradation is selected, it is randomly adhered together with either heat and or adhesives such that the end product retains a dimension stability of sufficient tensile and compressive strength that allows it to achieve 50% of its originally specified thickness and mechanical values even after 10,000 hours of exposure.

The present embodiment of the invention is produced with a flatness coefficient. This flatness coefficient allow the present invention the ability to perform in sport fields application where the overlying normal loads are only 5 to 10 lbs per sf. is highly resistant to thermal coefficient of expansion and contraction provided long-term Gmax and energy absorption properties, is easy to install, provides long term vertical fluid infiltration and long term horizontal fluid transmission. The present invention will last the lifetime of the field and will not degrade or densify over time. The present invention has an excellent Gmax on it own, as well it will enhance any turf system by providing a shock attenuation layer directly under the turf system. The cushion properties of the present invention will actually make the synthetic turf system last longer. Similar to any carpet material, utilizing a pad underneath will reduce the wear of the structure. The present invention is produced in a Quality Controlled environment, ensuring the client will get a consistent, uniform system throughout his sport field. The present invention will not store water, it is a flat pipe completely under your field. It can flow a minimum of 2.35 gallon/minute/foot to handle the most severe rainfall event.

Transmissivity tested by manufacturer every 100,000 square feet of product per ASTM D4716. Testing Conditions are: steel plate/geocomposite/geomembrane/steel plate. The transmissivity of certain embodiments of the present invention are reflected below:

Transmissivity:

| | ASTM 4716, GRI GC-8 | |
|---|---|---|
| Average | 50 PSF; 1% slope | 4.9 × 10E⁻⁰² m²/sec |
| Average | 50 PSF; 1% slope | 2.35 Gal/min/ft |

SDM is produced in roils typically 48′″×210′, to maximize speed of installation and minimize a. Material selection/composition . . . materials selected are a mix of medium and high density Cross-link PE foam shredded to a minimum of ½″ to a maximum gradation of ¾″, this gradation provides the optimum density of the invention while maintaining the required hydraulic and mechanical properties.

Desired thickness . . . Thickness is controlled by skiving, a process of planing the bottom of the invention or producing a product that minimizes tolerance of the overall thickness of 25 mm with a thickness tolerance +/−1 mm the desired thickness for the Sport field product. Any thickness deviation greater than +/−2 mm will result in a finished turf system that could be unsafe or visually defective.

Weight . . . weight of the structure is 6-14 ounces/sf for a thickness of 25 mm this weight allows for ease of installation minimizing the use of specialized equipment and provide the needed weight to maintain intimacy with the underlying layer.

Density . . . Medium and high-density crosslink PE foam, selected and sourced from recycled content to create a structure with minimum density of x to y. This density allows the materials to intimately conform to the subgrade, maintaining a semi-rigid structure while providing the necessary softness for impact attenuation. This density allows for the minimum of expansion and contraction related to the thermal coefficient of synthetic materials produced from PP, HDPE, and Ildpe.

Spacing of drainage grooves . . . minimum groove spacing of 2.5″ OC to a maximum spacing of 3″ OC rhombus shaped grooves . . . to maximize transmissivity while maintaining intimate contact with the subgrade or membrane protection layer.

Drainage grooves are formed within the structure during the forming process in the machine direction, i.e. with the roll. These drainage grooves are removed or not formed from the structure on the outside edge of each side of the roll. This allows the invention to ultimately lay flat on the subgrade. This smooth edge allows rolls to easily be seamed or joined in the field if so desired . . . This smooth edge allows for ease of installation in the field.

Tensile strength . . . Machine direction average values of 40 lbs/inch . . . MD. Cross Machine average values of 39 lbs/inch. TD using ASTM D 4595.

| | | | |
|---|---|---|---|
| Shock Attenuation: | Average | ASTM | 84 G_{MAX} (Aggregate), HIC 204 |
| | | F 355-A | 92 G_{MAX} (Concrete), HIC 252 |

| | The invention will reduce the overall GMAX on any | |
|---|---|---|
| | given sport surface. The underlying materials | |
| | will reduce long term GMAX by 20%_-40%. | |
| | Resistance to rotation | |
| Resistance to | Average | 35 NM |
| Rotation: | | |

Having thus described multiple illustrative embodiments of the invention, various alterations, modifications and improvements will readily occur to those skilled in the art. Such alterations, modifications and improvements are intended to be within the scope and spirit of the invention. Accordingly, the foregoing description is by way of example only and is not intended as limiting. The invention's limit is defined only in the following claims and the equivalents thereto.

What is claimed is:

1. A synthetic drainable base course comprising:
a. a layer of selectively graded high-density cross-link polyethylene foam having an upper surface and a lower surface; and
b. a plurality of channels disposed within said lower surface.

2. The synthetic drainable base course of claim 1 wherein the layer of selectively graded high-density cross-link polyethylene foam is produced under compression of at least five hundred pounds per square foot.

3. The synthetic drainable base course of claim 1 wherein the lower surface is textured to prevent movement on a subgrade or membrane.

4. The synthetic drainable base course of claim 1 wherein the layer of selectively graded high-density polyethylene foam includes a pair of borders along a first side and a second side free from the plurality of channels.

5. The synthetic drainable base course of claim 4 wherein the border is four inches.

6. The synthetic drainable base course of claim 1 wherein the channels are maximized to between 2½ inch and 3 inch centers.

7. A synthetic drainable base course comprising:
a. a layer of medium density polyethylene foam having an upper surface and a lower surface;
b. a plurality of channels disposed within said lower surface;
c. is deliverable in roll form at least up to 48″×210′;
d. is manufactured to roll across the width of a field to minimize seams;
e. is planed/shaved or manufactured to maintain a specific thickness tolerance; and
f. comprises a pressurized formation of layers.
